(19) United States
(12) Patent Application Publication
(10) Pub. No.: US 2008/0134866 A1
(43) Pub. Date: Jun. 12, 2008

(54) FILTER FOR DYNAMIC CREATION AND USE OF INSTRUMENTAL MUSICAL TRACKS

(76) Inventor: Arnold E. Brown, San Jose, CA (US)

Correspondence Address: Patent Venture Group, 10788 Civic Center Drive, Suite 215, Rancho Cucamonga, CA, 91730-3805, US

(21) Appl. No.: 11/737,288

(22) Filed: Apr. 19, 2007

Related U.S. Application Data
(60) Provisional application No. 60/874,690, filed on Dec. 12, 2006.

(51) Int. Cl. G10H 7/00

(52) U.S. Cl. 84/661

(57) ABSTRACT

A system for the extraction of vocal content from a musical track. A hardware platform and a multimedia software application are provided that are suitable for use in playback of the musical track. A filter software unit then dynamically intercepts the musical track in the hardware platform prior to its use there in playback. The filter software unit suppresses the vocal content from the musical track to create an instrumental track, and it passes the instrumental track on for use in playback immediately or after some period of storage.

### CROSS-REFERENCE TO RELATED APPLICATIONS

This application claims the benefit of U.S. Provisional Application No. 60/874,690, filed Dec. 12, 2006, hereby incorporated by reference in its entirety.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### INCORPORATION-BY-REFERENCE OF MATERIAL SUBMITTED ON A COMPACT DISC

Not applicable.

### BACKGROUND OF THE INVENTION

1. Technical Field

The present invention relates generally to electrical audio signal processing systems and devices, and more particularly to having provision for the reduction or elimination of an unwanted signal.

2. Background Art

When people sing along with musical tracks that contain no vocal tracks it is commonly called “Karaoke” (or “Interactive Music”). Karaoke is an increasingly popular form of entertainment that began in Japan in the 1970s and has since spread to virtually all parts of the world. A singer, who is typically an amateur, sings along with recorded music that is typically of a well-known song in which the voice of the original singer is absent or reduced in volume.

Only a few major elements are usually needed to allow people to perform karaoke. These are (1) a musical track that does not contain vocal tracks, but merely the instrumental tracks (hereafter called “instrumental musical tracks”); (2) lyrics to enable the user to know what words to sing; (3) lyric synchronization timing information to enable the user to know when to sing particular words that go with a particular song; and (4) an audio system with a microphone input to allow the user to generate a vocal track.

Various electronic systems can be provided to play the recorded music, to amplify and integrate the added audio performance by the “karaoke performer,” to present the lyrics and any other desired visual guidance to the performer, and sometimes to display visual materials to an audience. Traditionally systems that have been capable of more than simple playback of the underlying recorded music are termed “karaoke machines” or “karaoke systems” and these can be quite sophisticated.

Increasingly today, other, more generalized electronic systems are being used in manners similar to traditional dedicated karaoke machines. Many modern electronics devices, such as personal computers (PCs), set top boxes, mobile telephones, portable audio-video players, as well as many other audio-video electronic devices with software can be used to playback digital music files that contain a musical track. Such systems thus are inherently capable of providing at least element (1), noted above, for karaoke. Similarly, these systems now usually can provide elements (2), (3), and (4), that is, visual lyrics and timing information playback, and vocal input and output capabilities. Digital files for the music, visual, and other content stored in these systems can usually easily be stored on a compact discs (CD), digital versatile disk (DVD), hard drive storage, other magnetic disk storage, flash memory, or, generally, any other computer storage.

In marked contrast to the technology for karaoke performance, however, the approaches and equipment used to create the underlying instrumental musical tracks for karaoke have generally changed very little until relatively recently. One time honored and still very widely used approach is simply to record (or re-record) a musical performance as a new karaoke version without the voice of an original singer. Unfortunately, this can be subject to various constraints. For example, deceased artists obviously cannot re-perform their works and bringing together artists and/or music rights owners who no longer get along can be similarly problematic.

In addition to performer based approaches, technical approaches have been widely employed to create instrumental musical tracks for karaoke. For example, if an original musical performance has been recorded into a multi-track studio “master recording,” the track or tracks that include the voice of the original singer can be suppressed to produce (to “re-master”) a new karaoke version. Techniques are possible to remove the voice of an original singer from distribution-quality recordings. Of interest here are the various processes being used and being introduced today for creating instrumental music tracks by digitally removing the information associated with vocal tracks (hereafter called “vocal extraction”).

Currently, vocal extraction is accomplished by removing certain portions of the original music file, by either removing a channel associated with the music file (for example the center channel in a stereo recording) or by performing a more complex function on the file to remove sound ranges typically associated with vocal sounds. These vocal extraction techniques are typically reduced to algorithms that can be implemented in either software or hardware. Some of the algorithms can also be adjusted as the original recording is being processed, to adjust the balance, bass, treble, and other features. These adjustments can be made either as a function of time, so the adjustments occur as the song plays, or they can be made as a function of the frequency domain.

The existing approaches to vocal extraction, however, suffer from a range of limitations and the instrumental music tracks produced using them tend to be of lesser quality or to require professional level equipment and skills.

The quality end of this range of limitations is often characterized by inconstancy. For instance, for some music-vocal selections vocal extraction is effective and for others it is not, but with this being largely unpredictable and requiring users to try selections on a one-by-one basis.

Toward the middle of this range of limitations are amateur or “personal” karaoke systems that have some specialized digital signal processing capability and that provide the users some degree of tuning capability to improve the quality of vocal extraction. These systems are still often unsatisfactory for many potential users, who do not want a new specialized hardware and proprietary software based system when they usually already have one or more general audio-visual systems. In particular, many such potential users also just do not want to have to learn a new user-interface to a personal karaoke system and to deal with tuning many selections on what is still usually little more that a one-by-one basis.

Toward the professional end of this range of limitations are systems that provide professional, quality results with excellent vocal extraction. Alas, these systems usually require professional level expenditures of capital and human resources. The equipment at this level is expensive, learning to use it is daunting, and actually employing it is laborious.

As a result of the above, and other factors, the production and distribution of instrumental music tracks remains largely in the control of traditional music producers and this creates significant legal and social issues. For instance, instrumental music tracks for karaoke are usually regarded by music producers as new revenue sources, and thus often not available to potential karaoke performers due to the expense or lack of availability. On one hand, managing the “production-side issues” and putting quality instrumental music tracks into channels of distribution do entail appreciable costs to the music producers or service providers. On the other hand, potential karaoke performers question why they should have to buy karaoke versions of selections when they typically already own non-karaoke versions, and they chafe at per-play charges for karaoke instrumental music tracks that can be orders of magnitude higher than per-play charges for regular music in public venues (e.g., at “karaoke bars” versus jukeboxes).

### BRIEF SUMMARY OF THE INVENTION

Accordingly, it is an object of the present invention to provide a dynamic filter for the creation and use of instrumental musical tracks.

Briefly, one preferred embodiment of the present invention is a system for extraction of vocal content from a musical track. A hardware platform and a multimedia software application suitable for use in playback of the musical track are provided. A filter software unit then dynamically intercepts the musical track in the hardware platform prior to use in playback, suppresses the vocal content from the musical track to create an instrumental track, and passes the instrumental track on for use in playback.

Briefly, another preferred embodiment of the present invention is a process for extracting vocal content from a musical track. The musical track is dynamically intercepted in a multimedia software application prior to its use in playback. The vocal content is then suppressed from the musical track, thereby creating an instrumental track. And the instrumental track is passed in place of the musical track.

These and other objects and advantages of the present invention will become clear to those skilled in the art in view of the description of the best presently known mode of carrying out the invention and the industrial applicability of the preferred embodiment as described herein and as illustrated in the figures of the drawings.

### BRIEF DESCRIPTION OF THE SEVERAL VIEWS OF THE DRAWING(S)

The purposes and advantages of the present invention will be apparent from the following detailed description in conjunction with the appended figures of drawings in which:

FIG. 1 is a schematic block diagram illustrating an exemplary embodiment of a vocal extraction system in accord with the present invention;

FIG. 2 is a schematic block diagram illustrating how the multimedia software of FIG. 1, utilizing the filter software and a filter file elements of the vocal extraction system, changes a conventional full music track into an instrumental musical track;

FIG. 3 is a diagram that graphically conceptually illustrates one manner in which a filter file can change a full music track into an instrumental music track;

FIG. 4 is a block diagram depicting the general contents of a representative filter file; and

FIG. 5 is a schematic block diagram illustrating some more sophisticated exemplary embodiments of the vocal extraction system, ones particularly including delivery mechanisms.

In the various figures of the drawings, like references are used to denote like or similar elements or steps.

### DETAILED DESCRIPTION OF THE INVENTION

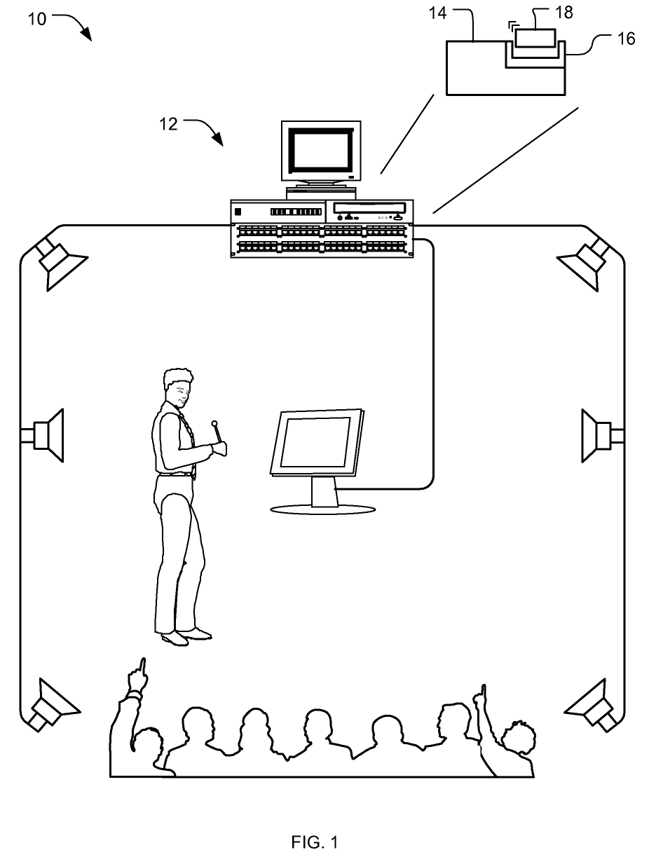

A preferred embodiment of the present invention is a filter for the dynamic creation and use of instrumental musical tracks. As illustrated in the various drawings herein, and particularly in the view of FIG. 1, preferred embodiments of the invention are depicted by the general reference character 10.

FIG. 1 is a schematic block diagram illustrating an exemplary embodiment of a vocal extraction system 10 in accord with the present invention. The vocal extraction system 10 typically resides in a hardware platform 12 that hosts multimedia software 14 that can employ a filter software unit 16. Optionally, the filter software unit 16 can utilize a filter file 18.

The hardware platform 12 here can be entirely conventional and may, of course, consist of multiple devices assembled as a system able to perform the tasks desired of the hardware platform 12 in the vocal extraction system 10. For example, the hardware platform 12 can include multiple video display systems. Typically one display will be provided for the karaoke performer (or performers), to provide such performers with lyric and timing information. Additionally, one or more displays can optionally be provided for a “karaoke jockey” (a facilitator similar in concept to a traditional disc jockey or video jockey). And one or more displays can optionally be provided for an audience, to provide them with lyric information and/or to display a video or visual animation as additional entertainment. The hardware platform 12 here can include one or more speakers, microphones, and amplifiers with suitable microphone inputs and speaker outputs.

Alternately, the hardware platform 12 can consist of as little as one integrated device, say, one resembling a conventional “personal” DVD player with an added microphone and speakers rather than just earphones.

The hardware platform 12 hosts the multimedia software 14 and, accordingly, this means that the hardware platform 12 has some degree of digital processing capability. As most electronics hardware systems today employ at least one microprocessor, however, there is no shortage of candidates for the hardware platform 12. For instance, most personal computers (PCs), many personal digital assistants, and even many cellular telephones today are suitable for use as or as part of the hardware platform 12 because these can host the multimedia software 14. Those skilled in the art will appreciate that numerous other existing and emerging electronic systems are also suitable.

The multimedia software 14 here can also be entirely conventional, and the inventor anticipates that in many embodiments of the inventive vocal extraction system 10 this will be the case. Many suitable candidates for the multimedia software 14 already exist and are in wide use. Some common examples are Windows Media Player™ from Microsoft Corporation of Redmond, Wash.; Musicmatch Jukebox™ from Yahoo! Inc. of Sunnyvale, Calif.; and Quicktime™ and iTunes™ from Apple, Inc., Cupertino, Calif.

Many of the candidates for use as the multimedia software 14 are particularly characterized by their use of modules called “plug-ins,” and this is generally a trend in the software industry. Most multimedia software playback applications today contain a mechanism or modular structure that allows a separate software application, i.e., a plug-in, to interface with the multimedia software playback application for purposes of providing security features, visual representations, or other added functionality. Separate or third party companies or individuals often write software plug-ins for these multimedia software playback applications. Some plug-ins can be very simple and some can be very complex.

Embodiments of the inventive vocal extraction system 10 can be based on the convenience of plug-ins. The filter software unit 16 thus can contain the code necessary to directly perform vocal extraction. Alternately, the filter software unit 16 can contain the code necessary to decode a filter file 18, and to decrypt it in cases where all or part of it is encrypted. Additionally, the filter software unit 16 contains the code necessary to interface with the multimedia software 14 as needed.

In view of prevalence of multimedia software 14 with plug-in capability, the inventor anticipates that many embodiments of the vocal extraction system 10 will use this approach, and the examples presented herein are based on this. Nonetheless, this should not be taken as implying that specialized, dedicated, or other non-conventional instances of the multimedia software 14 are not embraced within the scope of the present invention.

Various approaches can be used in the filter software unit 16 to work with the audio decode engine of the multimedia software 14. For instance, it can dynamically intercept musical tracks in the hardware platform 12 and based on criteria direct the multimedia software 14 to suppress or modify certain of the audio information as the multimedia software 14 performs its playback function, say, to decrease the volume for certain playback of the audio such that it is inaudible or to adjust the equalizer or stereo playback so that vocal track information is effectively muted. The criteria used for this can be user-specified locally at the hardware platform 12, based on an analysis of the musical track, or can be looked up in a database of pre-determined criteria.

The analysis employed for this can be conventional in nature, or otherwise, but is novel here because it is employed dynamically to capture a musical track normally destined for playback, extracts the vocal content from the musical track to create an instrumental track, and then passes the instrumental track on for playback instead (albeit, often with new vocal content added and with lyrics information, i.e., for karaoke use; described further presently).

Alternately, different versions of the filter software unit 16 may be provided to use the filter files 18 in different ways to accomplish the goal of suppressing the vocal content, modifying the pitch depending on the multimedia playback software and the type of device (i.e., hardware) on which the multimedia software 14 is running, and adding additional content to the net result (e.g., lyrics information). The filter software unit 16 can follow rules established in manufacturer documentation governing the functioning of plug-ins for the particular multimedia software 14, and thus can be designed to achieve maximum efficiency in the creation of instrumental musical tracks and to provide users with the best interactive music experience.

Since the filter software unit 16 can be embodied to employ multiple methods to eliminate the vocal track information, information about how the filter software unit 16 works can also be published to allow others to produce filter files 18. The filter software unit 16 thus can allow users to publish, save, or upload to a network (e.g., the Internet) their filter files 18 so that individual's versions of these can be made available for playback with or without those individual's vocal tracks to go with full music tracks.

In view of the flexibility that filter files 18 provide, the inventor anticipates that many embodiments of the vocal extraction system 10 will use them, and the examples presented herein are based on this. Nonetheless, this should not be taken as implying that other approaches are not embraced within the scope of the present invention.

Those skilled in the art will readily appreciate that yet other approaches can also be employed. If desired, new instances of the multimedia software 14 can be coded that directly perform dynamic vocal extraction or that accept filter files 18. For instance, a cellular telephone manufacture or a cellular telephone network provider might craft a particularized form of the multimedia software 14 to run on their telephones. In this manner one or more people could, for example, use their cell phones in embodiments of the vocal extraction system 10, and such mobile phones can function as the hardware platform or act in concert with other hardware over 3G or cellular networks to function as the hardware platform 12.

FIG. 1 may initially evoke thoughts of traditional karaoke performance rather than a scenario where karaoke instrumental musical tracks are produced, before moving on, however, a key point to note is that it is both. The inventive vocal extraction system 10 dynamically can produce the instrumental musical track at the time of karaoke performance, using the multimedia software 14, the filter software unit 16, and, optionally, a filter file 18 at that time. As discussed presently, this provides a number of advantages over prior art approaches to vocal extraction.

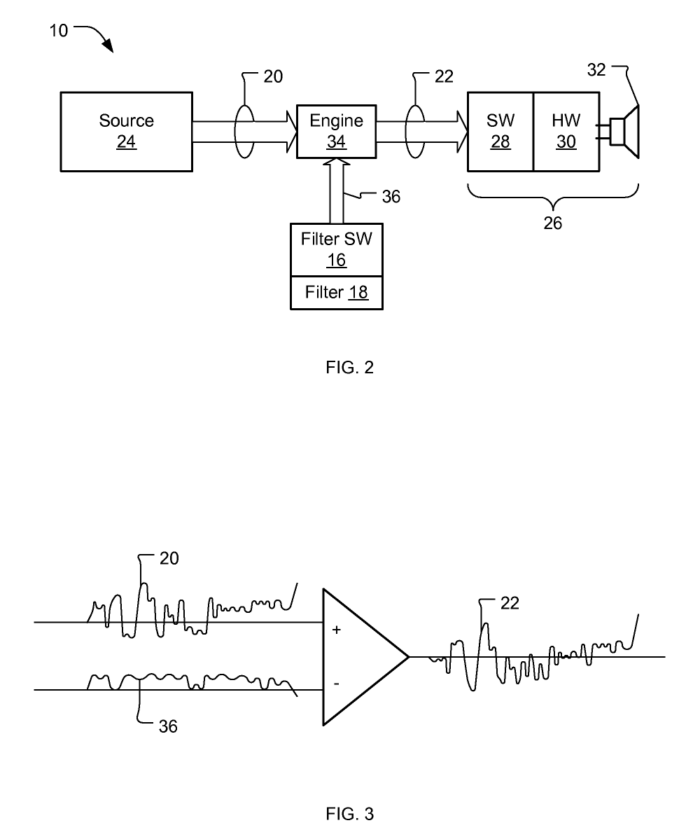

FIG. 2 is a schematic block diagram that illustrates how the multimedia software 14, utilizing the filter software unit 16 and a filter file 18, changes a conventional full music track 20 into an instrumental music track 22. The full music track 20 can be provided by any music source 24. For example, the music source 24 can be a music file located on a computer hard drive, CD, DVD, tape, LP, or even a radio or television broadcast. The only real limitation on the music source 24 is that it provide the full music track 20 in a form suitable as input to a conventional music platform 26. The music platform 26 shown here is a generic music player having software 28, hardware 30, and a speaker 32. But in an alternate embodiment the speaker 32 might be replaced with a recording device.

The difference in FIG. 2 from a traditional music playback or recording system is the addition of a processing engine 34 that runs the multimedia software 14 with the filter software unit 16 and a filter file 18. The processing engine 34 here is stylistically shown distinct from the music platform 26 to emphasize how it works conceptually. As a practical matter, however, in most embodiments the underlying software 28 and hardware 30 in the music platform 26 is expected to be the processing engine 34, especially when the full music track 20 is in digital form. For example, if the music source 24 is a CD and the music platform 26 is a personal computer the software 28 and the multimedia software 14 can be the same and can be Windows Media Player™, and the filter software unit 16 can be a plug-in as described above.

In this manner, starting with an original full music track 20 and using a separate filter file 18, a user gets the experience of playing the instrumental music track 22 without actually “possessing” an instrumental music track in the traditional sense. The present invention thus solves an important problem in that it requires no separate license for the instrumental music track. The original sound recording artists and the music publisher still benefit, to the extent that they would conventionally, by virtue of the end user needing the original full music track 20, and the end user now benefits by being able to more fully use the original full music track 20. To the extent that copyright law might initially appear to raise issues, that will generally not be the actual case because of the non-tangible, ephemeral nature of the instrumental music track 22, or they will fall under the various copyright law fair use exceptions. As will also be discussed, presently, this dynamic creation, or “on-the-fly” creation, of the instrumental music tracks 22 permits a variety of business models and new user functionalities and allows a broader adoption of interactive music uses, especially in digital files.

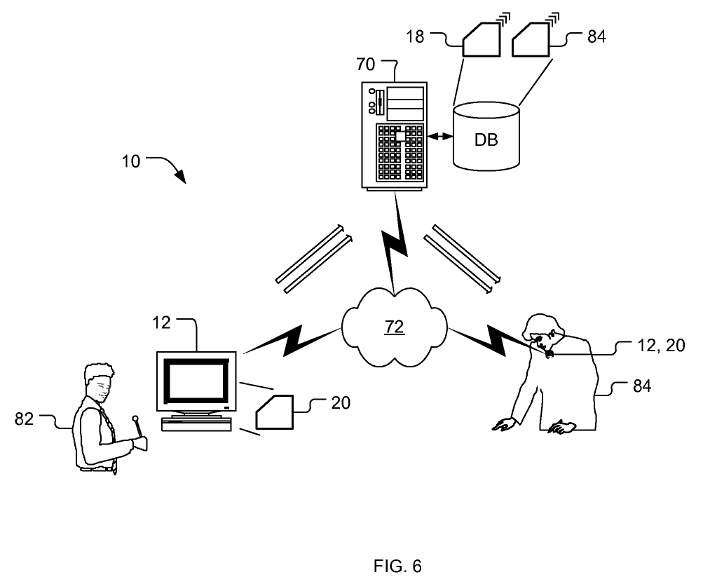

If a user saves newly created music they can actually be saving a new vocal track file and the filter file 18 separately. If they then elect to post these two files together with the original full music track 20, say, on a network like the Internet (see e.g., FIG. 5), anyone else can use the filter software unit 16 to playback these three elements to produce the same result (i.e., the performing user's karaoke performance). This is also important if the performing user does not post the original full music track 20, because only the new vocal track file and the filter file 18 are needed to allows other users to recreate the experience if they already have the original full music track 20. No additional copyright license is then necessary. To post a karaoke performance for others to listen to only requires posting the new vocal track file and the filter file 18, or pointers to where these are stored. Accordingly, websites can implement this functionality as a service, storing individual user's vocal track files and filter files 18, yet avoid copyright licensing requirements for the original full music tracks 20 because the user's vocal track files and filter files 18 are derivative works of the full music tracks 20 in the legal sense. In this regard, the inventive vocal extraction system 10 enables entirely new Internet-based services without the legal issues encountered by many other Internet-based music services.

FIG. 3 is a diagram that graphically illustrates one manner in which a filter file 18 can conceptually change a full music track 20 into an instrumental music track 22. Simply put, the filter file 18 here includes filter data for a filter signal 36 that cancels out the vocals of the full music track 20.

The use of filter data in this manner can be either (A) on an unique musical recording basis (per song basis); (B) on a class of musical recordings basis (for example, for all rock music files); or (C) an universal filter for use with all musical tracks. If used on a unique or “fingerprint” basis the quality of the vocal extraction will be improved and the quality of the instrumental music track 22 will be more improved.

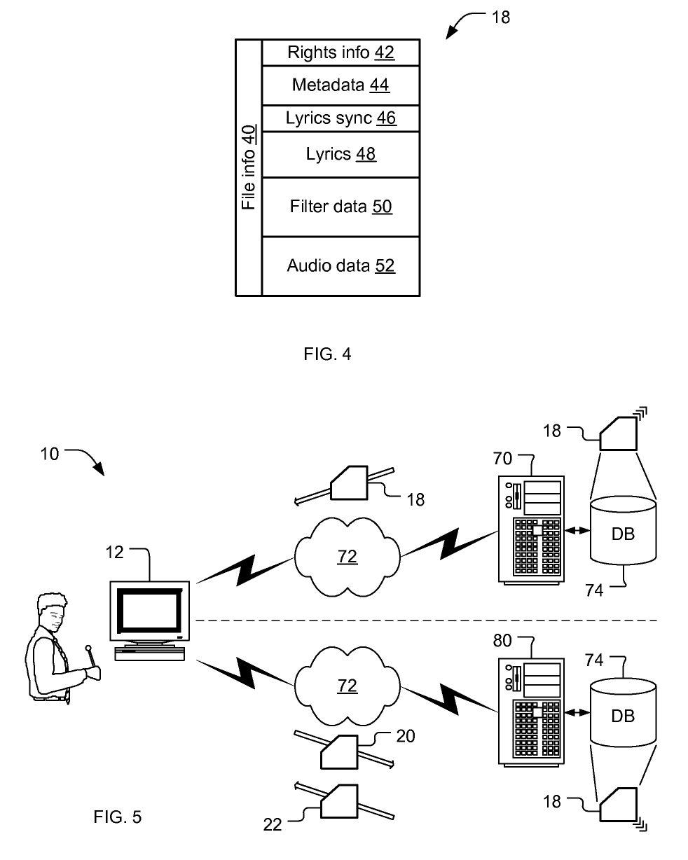

FIG. 4 is a block diagram depicting the general contents of a representative filter file 18. The filter file 18 here includes file information 40, rights information 42, other metadata 44, lyric sync information 46, lyrics information 48, filter data 50, and digital audio data 52. As shown, all of the information needed, even including the original digital audio data 52, may be contained in the same filter file 18. Alternately, this can be located in separate locations or a combination thereof.

The file information 40 can be conventional, including information about the file format, file extension, handling instructions, an integrity checksum, etc. The rights information 42 is optional, but may be present as needed if there are rights that apply to any of the other information or data in the filter file 18. For example, if present, the digital audio data 52 typically will have rights that apply, and the filter data 50 and the lyrics information 48 may as well.

The other metadata 44 is essentially a catch-all. Anything not substantial enough to merit a section of its own or anything additional desired can go here. For example, the filter files 18 here can contain information about pitch to allow the multimedia software 14 to dynamically modify the pitch of an instrumental music track 22 to make it easier for a singer to sing along with a particular song. Since a filter file 18 will often be unique to a particular song in most cases, the pitch modification can thus be optimized for a particular song.

The lyric sync information 46 is straightforward. Similarly, the lyrics information 48 is generally straightforward. For convenience, the lyrics information 48 and the lyric sync information 46 can simply be spoken of as lyrics information. Optionally, the actual lyrics can be provided in multiple languages and/or enhanced with phonetic clues. The filter data 50 is described throughout this discussion.

The digital audio data 52 is optional. If provide, however, it can include a compressed or uncompressed instance of a full music track 20. With reference back also to FIG. 2 briefly, it can be seen that the filter file 18 here in FIG. 4 effectively includes the music source 24. The filter file 18 shown here thus is a particularly sophisticated example that can be used with advanced delivery mechanisms, discussed presently. Of course, the filter file 18 may instead be delivered separately and never combined with a full music track 20 until both are utilized during playback.

One way to implement the filter files 18 is to use a file format that designates how the lyric sync information 46, lyrics information 48, and filter data 50 are supplied. Music file formats today are often structured to permit not only encoded audio information, but also metadata information as well as information about permissions or rights (e.g., as the other metadata 44 and rights information 42 here).

For example, one popular digital music file format today is MPEG 1 Audio Layer 3, commonly referred to as “MP3.” This is often associated with a header file structure known as “ID3V2,” and it is this header file structure that can contain additional information about an MP3 file. This information is thus attached to the MP3 file and appends the audio file with the metadata information. Other file formats also have structures that perform much of the same functions of the ID3V2 structure, but in a proprietary manner. Thus, the filter data 50 of the inventive vocal extraction system 10 can be included in this file structure (or header file) and then called upon only when a user requests an instrumental music track 22 rather than the original full music track 20.

In this manner, one digital music file can be able to produce two very different experiences: one that is the original full music track 20 and the other that is the interactive instrumental music track 22 with vocals extracted and time synchronized lyrics displayed.

In the inventor's presently preferred embodiment of the vocal extraction system 10 the filter file 18 is in XML form and the filter software unit 16 works with this to direct the multimedia software 14, but the actual language need not be any specific one and can be a text or data file and can be written in any language that is efficient to retain and transmit data between applications. Indeed the filter file 18 in most cases is expected to be a part of a music or video file format and will therefore be structured so as to meet that particular file format protocol.

As already mentioned in passing, the filter files 18 may be fully or partially encrypted, so that the unique information provided therein can be kept secret or proprietary, preventing others from unauthorized use—and thus enabling business models were money is derived from the sale of or the use of the filter files 18.

In summary, the filter file 18 is a set of information expressed in computer code that enables conventional karaoke tasks and that further, via the filter software unit 16, informs the multimedia software 14 what audio ranges to eliminate at what time during the playback of a full music track 20. The dynamic filtering process used allows virtually all of the vocal track information in the full music track 20 to be discarded during playback. For the filter file 18 to do this the filter software unit 16 contains an appropriate decode mechanism capable of reading the filter file 18 and acting upon the information contained in it.

FIG. 5 is a schematic block diagram illustrating some more sophisticated exemplary embodiments of the vocal extraction system 10, ones particularly including delivery mechanisms. Many of the existing and emerging candidates for use as the multimedia software 14 are also particularly characterized by having an ability to work with network resources, including servers on the Internet. FIG. 5 shows two ways that the vocal extraction system 10 can employ this.

First, the filter files 18 can be obtained from a filter file server 70 that is accessible via the Internet 72. This can be done in real time or earlier (also called “in the background”), to permit the user to perform dynamic generation of instrumental music tracks 22 on their own hardware platform 12 using the multimedia software 14, the filter software unit 16, and thus obtained filter files 18. For this the filter file server 70 has a filter file database 74 of filter files 18 for various recorded original full music tracks 20. This filter file database 74 includes at least one field that is a unique identifier representing each indexed original full music track 20, and another field that relates to at least one identifier of a suitable filter file 18 (multiple filter files 18 for a single full music track 20 are possible, if desired). The filter file database 74 then further is a repository of all the filter files 18 that correspond to these unique identifiers. The filter file server 70 here can be an essentially conventional computer server that serves the filter files 18 using various protocols, including but not limited to HTTP, WAP, and other transmission protocols, to the hardware platforms 12 of remote users as requested. The filter file server 70 may deliver the filter files 18 in batch or on an individual basis. Additionally, the filter file server 70 may request credentials, payment, authentication, and proof of subscription or other access rights in order to serve the requested information.

The second server-based approach depicted in FIG. 5 uses the filter software unit 16 at the user's hardware platform 12 to work with a filtering server 80. The filter software unit 16 here still resides at the user's hardware platform 12 and works with the multimedia software 14 that is present there, but rather than use filter files 18 locally, the filter software unit 16 here handles communications with the filtering server 80 to perform real time processing of a full music track 20 and thus to allow the user to play, listen to, or save it is an instrumental music track 22 with the vocal track recording stripped out, or to allow the user to generate an instrumental music track 22 dynamically together with lyric information. In this dynamic scenario the original full music track 20 will in most cases be located on a user's hard drive or local storage, but could also be located on a different server or device. Here the user is effectively streaming (or uploading) his or her own content to the filtering server 80, where the it then utilizes a filter file 18 associated with the respective full music track 20 to strip out the vocal track information and passes the stream back through to the end user's multimedia software 14 on their hardware platform 12.

FIG. 6 is a schematic block diagram illustrating some of the technologies and services that the vocal extraction system 10 enables. Here a first user 82 creates a filter file 18 and a vocal track file 84 for use with a full music track 20. The first user 82 then uploads their filter file 18 and vocal track file 84, but not a copy of the full music track 20, to a server on the Internet 72. Then a second user 86 can download the filter file 18 and vocal track file 84, and with a copy of their own of the full music track 20 and a suitable hardware platform 12 (depicted here as a cellular telephone), the second user 86 can enjoy the full karaoke performance by the first user 82.

Many variations of this are possible. For example, without limitation, the first user 82 might simply not upload filter file 18, and only upload their vocal track file 84 to go with one or more filter files 18 that are already stored on the filter file server 70. Or the first user 82 might have downloaded a filter file 18 from the filter file server 70 (or another source), modified it, and now uploads their modified version. For that matter, the first user 82 might elect to upload multiple different filter files 18. Similarly, the first user 82 can upload multiple different vocal track files 84, say, ones in different styles or in different languages. Then the second user 86 can download what they prefer.

In summary, the present inventive vocal extraction system 10 allows filter information to be added to file formats either dynamically or permanently through an addition or creation function. Thus, a music library of a user can be updated or modified to include all or some filter files 18 that are associated with individual songs (full music tracks 20), or types of songs, or even universally. Typically, audio files today are either uncompressed or compressed audio that is produced by recording companies and published as CDs or as downloads available on Internet services, such as iTunes™ by Apple Computer. The present invention can add functionality to a user's collection of such digital music files, by allowing them to marry their digital music collection with one or more filters (or also with filters, lyric information, and lyric synchronization information) and to get a full karaoke or interactive music experience.

This interactive music experience also allows users to generate their own works by using a microphone to add their own vocal tracks to an instrumental music track 22, to generate a new work that is a “user generated music file.” Video or still images can further be added to this to create a new “user generated audio-video work.” Such new user generated music works and new audio-video works can then be saved, uploaded to computer servers, shared with other users, or stored on memory systems for posterity.

While various embodiments have been described above, it should be understood that they have been presented by way of example only, and that the breadth and scope of the invention should not be limited by any of the above described exemplary embodiments, but should instead be defined only in accordance with the following claims and their equivalents.

### INDUSTRIAL APPLICABILITY

The present vocal extraction system 10 is well suited for application in vocal extraction. The invention works with full music tracks 20 from essentially any source, including CDs, magnetic tape, DVDs, computer storage and memory (for example, hard disk drives and flash), as well as other forms of fixed media used to record and store digital music. Additionally, the source for the full music tracks 20 need not necessarily be local to the hardware platform 12. For example, it can be stored remotely on a network and be retrieved or can even be streamed over the Internet.

The filter software unit 16 of the inventive vocal extraction system 10 can dynamically intercept musical tracks in the hardware platform and perform vocal extraction as needed. This can be based on the uniqueness of each musical recordings, or based on the class (or genre) of the musical recordings, or based on an universal filter for use with all musical tracks. Furthermore, the criteria or data used for this can be user-specified, based on analysis of the full music tracks 20, based on information looked up in a database, or based on filter data 50 in a filter file 18. The full music tracks 20 and the criteria or data used can also be stored together or separately. For instance, a commercial CD containing full music tracks 20 can now additionally include filter data 50 and lyrics information 48, thus permitting a purchaser to use the CD for standard playback or for karaoke purposes.

Enhanced and entirely new capabilities are enabled by the vocal extraction system 10. For example, in one scenario involving the use of a unique filter file 18, the user can initiate a request for an instrumental music track 22 by executing a command on their multimedia software 14 to request a filter file 18 that corresponds with a full music track 20 from a server or from a local cache. If used in connection with identification software, also known as musical track recognition software, the code commonly used by a song identification database (e.g., CDDB™ or Gracenote™) can be used to obtain a filter file 18 that is unique to the full music track 20. The filter file 18 is then used by the filter software unit 16 to dynamically modify the full music track 20 that the multimedia software 14 would normally play.

For the above, and other, reasons, it is expected that the vocal extraction system 10 of the present invention will have widespread industrial applicability and it is therefore expected that the commercial utility of the present invention will be extensive and long lasting.

What is claimed is:

1. A system for extraction of vocal content from a musical track, comprising:
a hardware platform and a multimedia software application suitable for use in playback of the musical track; and
a filter software unit to dynamically intercept the musical track in said hardware platform prior to said use in playback, to suppress the vocal content from the musical track to create an instrumental track, and to pass said instrumental track for said use in playback.

2. The system of claim 1, wherein said filter software unit is a plug-in software component to said multimedia software application.

3. The system of claim 1, wherein said filter software unit suppresses the vocal content from the musical track based on criteria for the musical track.

4. The system of claim 3, wherein:
said criteria are obtained by a member of the set consisting of:
specification by a user of the hardware platform;
analysis of the musical track performed by said filter software unit; and
look-up in a database.

5. The system of claim 1, wherein said filter software unit suppresses the vocal content from the musical track based on a filter file.

6. The system of claim 5, wherein said filter file further includes at least one member of the set consisting of the musical track, lyrics information related to the musical track, and legal rights information related to the musical track.

7. The system of claim 1, wherein:
the vocal content being extracted is an original vocal content
said hardware platform includes a connection to a global communications network; and
said filter software unit is further to communicate with a remote location on said network to procure from said location at least one member of the set consisting of:
the musical track;
criteria for the musical track directing how said filter software unit suppresses the vocal content from the musical track;
lyrics information related to either the musical track or said instrumental track; and
a new vocal content related to either the musical track or said instrumental track.

8. The system of claim 7, wherein said filter software unit is further to obtain an identifier of the musical track and to communicate said identifier to said location.

9. The system of claim 1, wherein:
the vocal content being extracted is an original vocal content;
the musical track that said original vocal content is extracted from is an original musical track;
said hardware platform is further to input a new vocal content; and
one of said filter software unit and multimedia software application is further to accept said new vocal content, to combine said new vocal content and said instrumental track to create a new musical track, and to pass said new musical track for said use in playback.

10. The system of claim 1, wherein:
said hardware platform includes a display;
said multimedia software application is capable of controlling said display; and
said filter software unit is further to direct said multimedia software application to present lyrics information during said use in playback.

11. A process for extracting vocal content from a musical track, the process comprising:
(a) intercepting the musical track dynamically in a multimedia software application prior to use in playback;
(b) suppressing the vocal content from the musical track, thereby creating an instrumental track; and
(c) passing the instrumental track in place of the musical track.

12. The process of claim 11, further comprising after said (c), playing the instrumental track in place of the musical track.

13. The process of claim 11, wherein said (b) and said (c) are performed by a plug-in software component controlling said multimedia software application.

14. The process of claim 11, wherein said (b) is based on criteria for the musical track that are obtained by a member of the set consisting of:
specifying by a user of the process;
analyzing the musical track; and
looking up in a database.

15. The process of claim 11, wherein said (b) is based on a filter file.

16. The process of claim 15, further comprising, before said (b), procuring said filter file from a remote location on a global communications network.

17. The process of claim 16, wherein said procuring includes:
obtaining an identifier of the musical track; and
communicating said identifier to said location to identify said filter file.

18. The process of claim 15, wherein said filter file includes the musical track and the process further comprises, before said (a), retrieving the musical track from said filter file.

19. The process of claim 15, wherein said filter file includes lyrics information and the process further comprises:
retrieving said lyrics information from said filter file; and
after said (c), playing the instrumental track in place of the musical track while displaying said lyrics information to a user of the process.

20. The process of claim 15, further comprising:
receiving new vocal content from a user of the process; and
after said (c), playing the instrumental track in place of the musical track while accompanying the instrumental track with said new vocal content.
